(19) United States
(12) Patent Application Publication
(10) Pub. No.: US 2007/0160715 A1
(43) Pub. Date: Jul. 12, 2007

(54) Apparatus and method of making pizza

(75) Inventors: Ossama Elnakib, Dallas, TX (US); Peter G. Graham, Lucas, TX (US); Todd W. Craig, Frisco, TX (US); Chris Adelmann, Coppell, TX (US)

Correspondence Address: DICKE, BILLIG & CZAJA, FIFTH STREET TOWERS, 100 SOUTH FIFTH STREET, SUITE 2200, MINNEAPOLIS, MN, 55402, US

(73) Assignee: PIZZA HUT, INC.

(21) Appl. No.: 11/327,564

(22) Filed: Jan. 6, 2006

(51) Int. Cl. A21D 13/00

(52) U.S. Cl. 426/94

(57) ABSTRACT

A pizza includes a substantially flattened dough member and a plurality of self-contained topping portions. The dough member defines a top surface and the plurality of self-contained topping portions are maintained on the top surface of the dough member. In particular, each of the plurality of self-contained topping portions includes a topping selection and is surrounded by an exposed portion of the top surface of the dough member. Furthermore, the top surface of the dough member is imprinted with a first pattern extending between each of the plurality of self-contained topping portions and a second pattern extending about the plurality of self-contained topping portions.

### BACKGROUND OF THE INVENTION

Pizzas are often formed as baked, open-faced pies made of flattened dough, sauce, cheese, and other toppings. Consumers often wish to enjoy different styles or types of pizzas in one sitting. For example, consumers often desire pizzas made-to-order in one way on one portion of a pizza, and in another way on another portion of the pizza. Customers in a pizza restaurant, for example, might order one topping on one half of a pizza and another topping on another half of the pizza.

Potential difficulties arise, however, in that different topping types may not be distributed or maintained exactly as desired. As one example, one topping type intended for one portion of a pizza can spill over to another portion of the pizza when the pizza is made. As another example, toppings can slide off their intended portion of a pizza when the pizza is cut. As yet another example, pizzas can be improperly cut between differently prepared portions. In sum, combining pizza variations into a single pizza is often challenging.

### SUMMARY OF THE INVENTION

One aspect of the invention relates to a pizza including a substantially flattened dough member and a plurality of self-contained topping portions. The dough member defines a top surface and the plurality of self-contained topping portions are maintained on the top surface of the dough member. In particular, each of the plurality of topping portions includes a topping selection and is surrounded by an exposed portion of the top surface of the dough member. Furthermore, the exposed portion of the top surface is imprinted with a first pattern extending between each of the plurality of self-contained topping portions and a second pattern extending about the plurality of self-contained topping portions.

While aspects of a pizza according to one embodiment of the present invention have been described above, other related products, systems, and methods are also disclosed and provide additional advantages.

### BRIEF DESCRIPTION OF THE DRAWINGS

Embodiments of the invention are described with respect to the figures, in which like reference numbers denote like elements, and in which:

FIG. 1 is a top, perspective view of a pizza, according to an embodiment of the present invention;

FIG. 2A is a top, perspective view of a crimper, according to an embodiment of the present invention;

FIG. 2B is a bottom, perspective view of the crimper of FIG. 2A, according to an embodiment of the present invention;

FIG. 3A is a top, perspective view of a perforator, according to an embodiment of the present invention;

FIG. 3B is a bottom, perspective view of the perforator of FIG. 3A, according to an embodiment of the present invention;

FIG. 4A is a top, perspective view of a separator, or a divider, according to an embodiment of the present invention;

FIG. 4B is a bottom, perspective view of the separator, or divider, of FIG. 4A, according to an embodiment of the present invention;

FIG. 4C is a front, sectional view of the separator, or divider, of FIG. 4A along line 4C-4C, according to an embodiment of the present invention;

FIG. 5 is a top, perspective view of the perforator of FIG. 3A aligned to the crimper of FIG. 2A prior to assembly, according to an embodiment of the present invention;

FIG. 6 is a top, perspective view of the crimper and perforator of FIG. 5 in an assembled form and aligned to a dough member in a pan, according to an embodiment of the present invention;

FIG. 7 is a top, perspective view of the dough member of FIG. 6 following docking and patterning, according to an embodiment of the present invention;

FIG. 8 is a top, perspective view of the dough member of FIG. 7 with the divider of FIG. 4A, according to an embodiment of the present invention; and

FIG. 9 is a top, perspective view of the FIG. 1 pizza with cutting lines, according to an embodiment of the present invention.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense.

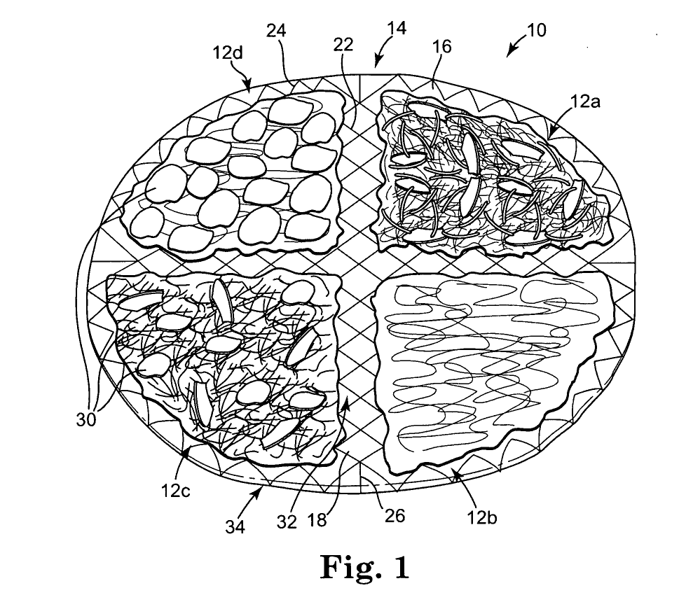

FIG. 1 shows a pizza 10, also described as an open-faced pie, in a baked state. It should be understood that the pizza 10 is optionally provided in an unbaked state, such as raw or frozen. The pizza 10 includes a plurality of individualized topping sections 12a-d, also described as self-contained topping portions or compartmentalized open-faced pies, and a common crust 14, also described as a crust, dough, or a dough member. In general terms, the plurality of individualized topping sections 12a-d are formed on the common crust 14 as individual units.

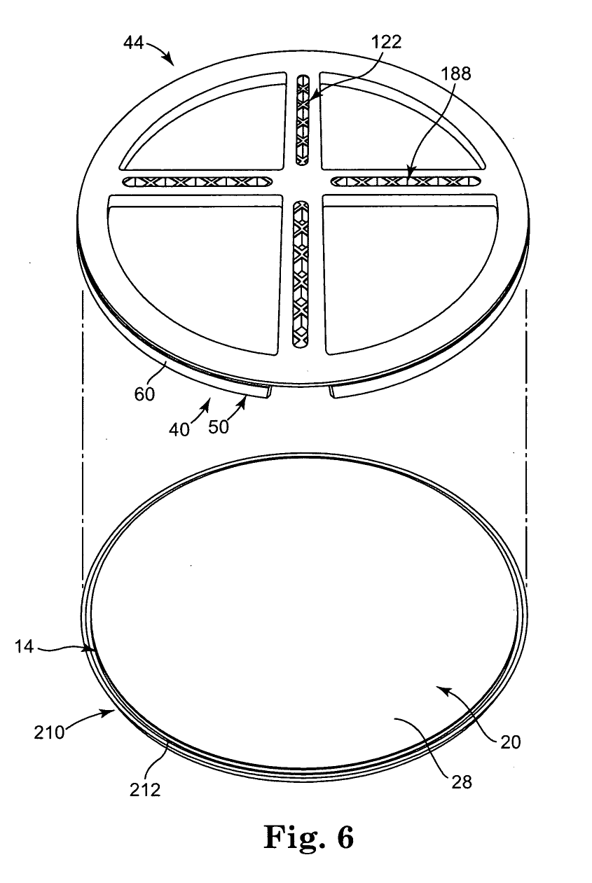

The common crust 14 optionally defines a top face 16, exposed portions 18, and topping support portions 20 (FIG. 7). The exposed portions 18 are substantially free of portions of the plurality of individualized topping sections 12a-d as desired. The exposed portions 18 are also optionally characterized by an inner pattern 22, also described as a first pattern, and an outer pattern 24, also described as a second pattern, imprinted into the top face 16 of the common crust 14. In order to assist in cutting, for example, the exposed portions 18 are optionally characterized by cutting marks 26. The topping support portions 20, also described as topping support sections, maintain the plurality of individualized topping sections 12a-d. Each of the topping support portions 20 is also optionally characterized by a plurality of perforations 28 (FIG. 7) imprinted into the common crust 14. From the above it should be understood that each of the plurality of individualized topping sections 12a-d is optionally surrounded by exposed portions 18 of the common crust 14. In this manner, each of the plurality of topping sections 12a-d is distinct, separate, spaced apart, or otherwise compartmentalized relative to adjacent topping sections.

Each of the plurality of individualized topping sections 12a-d includes selected toppings 30. The toppings 30 are disposed on an inner portion 32 defined by the crust 14. An outer portion 34 of the crust 14 is optionally substantially free of the toppings 30. The toppings 30 selected for each of the plurality of individualized topping sections 12a-d are chosen by a consumer, for example. One of the topping selections corresponding to a first one of the plurality of individualized topping sections 12a includes tomato sauce, onion, cheese, and sausage, according to one specific example, while a second one of the plurality of individualized topping sections 12b includes tomato sauce and cheese. It should be understood that any desired combination or selection of toppings is chosen for each of topping sections 12a-d.

As will be described in greater detail below, the topping sections 12a-d are separable into smaller portions as desired following baking. With reference to the description and figures, systems and methods for producing the pizza 10 will be described in greater detail.

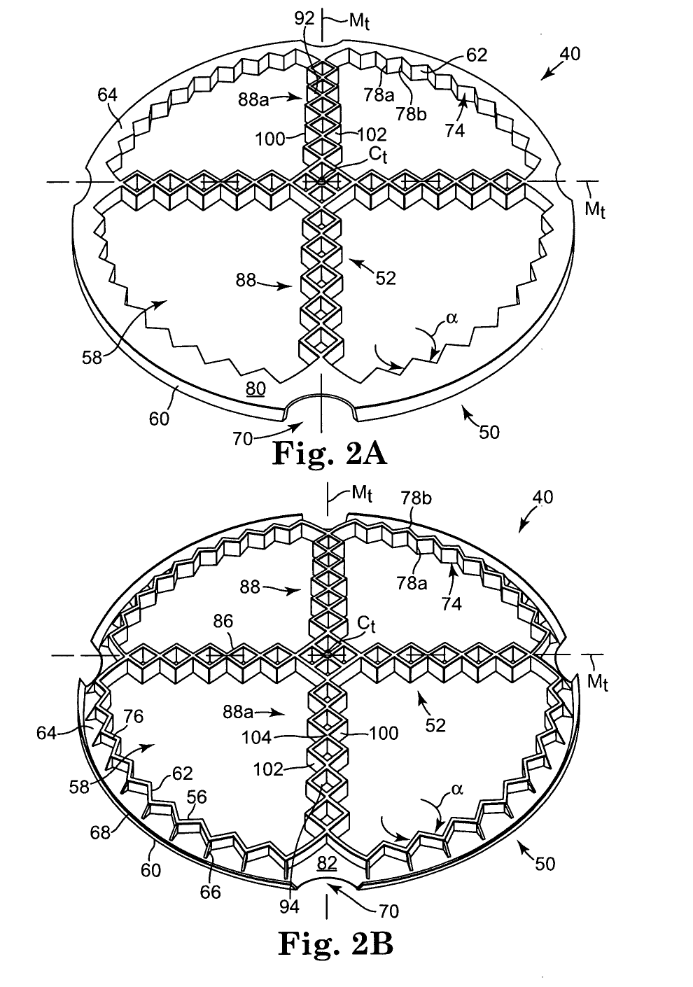

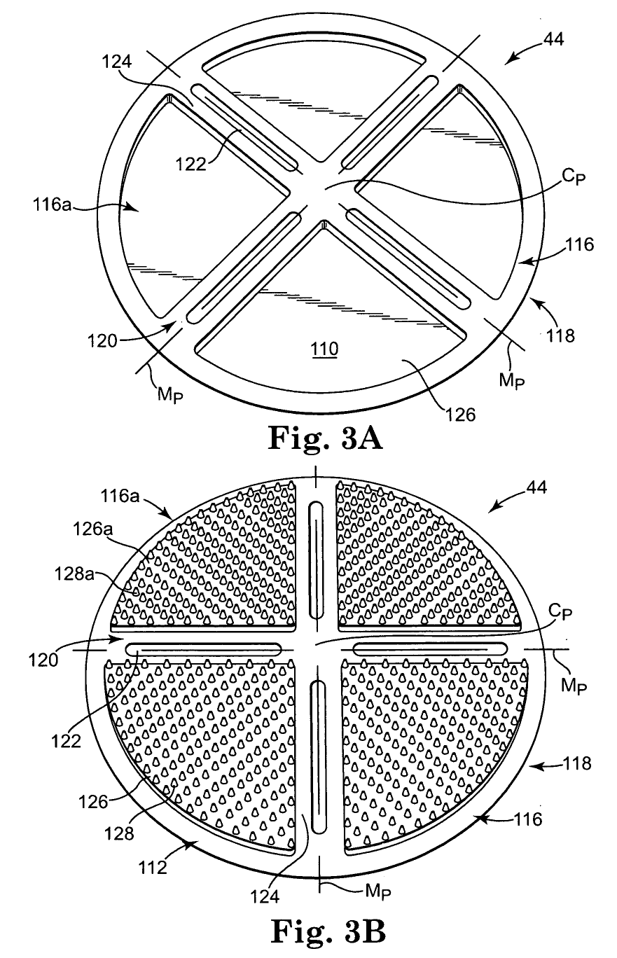

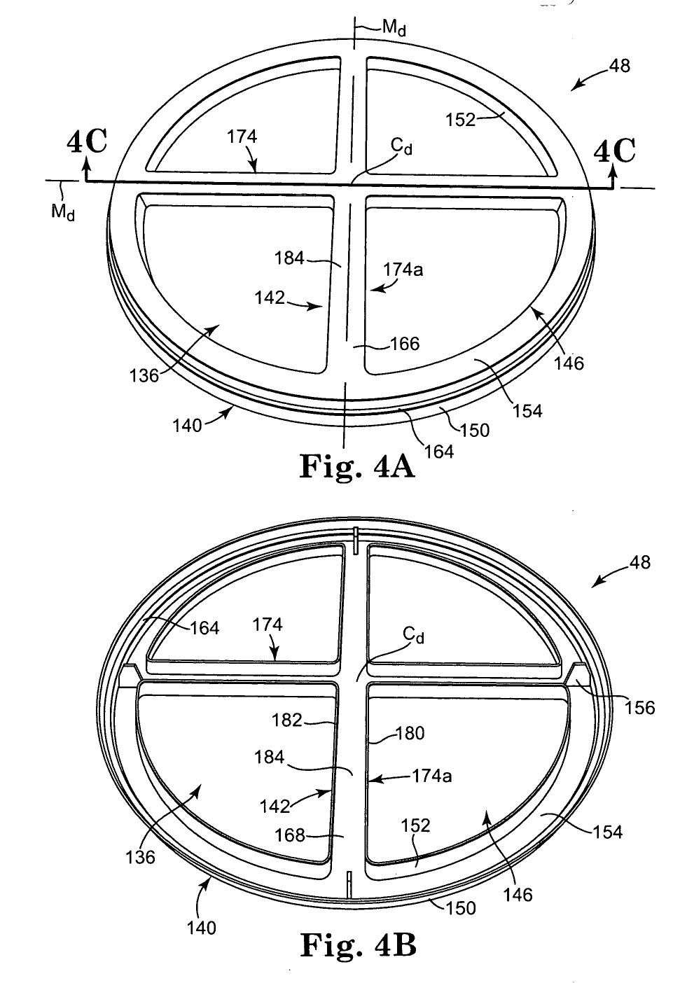

With reference to FIGS. 2A-4C, a system for making the pizza 10 optionally includes a crimper 40 (FIGS. 2A and 2B), also described as a patterning article, a perforator 44 (FIGS. 3A and 3B), also described as a docker, and a divider 48 (FIGS. 4A, 4B, and 4C), also described as a separator, a cover, a quality ring, or a topping guide. Individual components and portions thereof are optionally formed of a food-grade polymer, a corrosion resistant metal, or a metal with non-stick surface. Examples of food-grade polymers include, but are not limited to, polyethylene, polypropylene, polytetrafluorethylene (PTFE), and combinations thereof. Polymer-based components or portions thereof are fabricated using methods including, but not limited to, injection molding, extrusion molding, and machining techniques. Corrosion resistant metals include, but are not limited to, aluminum, chromium-plated steel, and stainless steel. Metal-based components or portions thereof are fabricated using techniques including, but not limited to, forging and machining. Non-stick coated materials include, but are not limited to, PTFE-coated aluminum.

FIGS. 2A and 2B show the crimper 40 from top and bottom perspective views, respectively. The crimper 40 defines a center Cₜ and includes a border press 50 and a center press 52. The crimper 40 is substantially continuously formed as a single piece such that the crimper 40 is substantially monolithic, or is a substantially unitary structure. However, separate, connected components are also contemplated. The crimper 40 or portions thereof are opaque, translucent, or clear/transparent in various embodiments.

The border press 50 extends about the center Cₜ of the crimper 40 and is substantially annular, or ring-shaped, although various shapes, for example rectangular, square, or triangular shapes, are also contemplated. The border press 50 defines a patterned bottom surface 56 and an interior 58, and includes an outer wall 60, an inner wall 62, a top wall 64, and a plurality of guides 66 extending from the inner wall 62 toward the outer wall 60.

The outer wall 60 is substantially smooth and projects downwardly from the top wall 64, the outer wall 60 terminating at a bottom end 68. The outer wall 60 optionally defines an outer transverse perimeter of the border press 50. The outer wall 60 extends substantially orthogonally from the top wall 64, or at an obtuse angle to the top wall 64, although other angles are contemplated. The outer wall 60 also optionally forms a portion of a plurality of grip openings 70 formed about the outer wall 60. Each of the grip openings 70 is sized to allow the user to place one or more fingers through the outer wall 60 to assist in lifting the crimper 40, if desired. The outer wall 60 is about 0.125 inches thick, is about 0.625 inches tall, and defines the transverse outer perimeter having a diameter of about 17.3125 inches, for example, although other dimensions are contemplated.

The inner wall 62 defines a series of angular faces 74 toward the interior 58 of the border press 50. The inner wall 62 projects downwardly from the top wall 64, the inner wall terminating at a bottom end 76. The inner wall 62 extends substantially orthogonally to the top wall 64, or at an obtuse angle to the top wall 64, although other angles are contemplated. The angular faces 74 of the inner wall 62 define peaks 78a and valleys 78b.

The inner wall 62 is about 0.09375 inches thick, is about 0.75 inches tall, and defines a minimum diameter at the peaks 78a of the angular faces 74 of about 15.0 inches and a maximum diameter at the valleys 78b of the angular faces 74 of about 15.75 inches, for example, although other dimensions are contemplated. Each of the angular faces 74 defines an angle α of about 90 degrees, although other angles are contemplated.

The bottom end 76 of the inner wall 62 defines the patterned bottom surface 56, or a patterning means, of the border press 50. The patterned bottom surface 56 optionally substantially corresponds to the outer pattern 24 of the pizza 10. For example, the bottom end 76 of the inner wall 62 is optionally characterized by, and used to imprint, a serrated, jagged, or otherwise repeating, angular pattern defined by a plurality of angled lines. It should be noted that other patterns, for example a plurality of diamonds, circles, squares, indicia such as words or branding images, and other patterns are also contemplated. Furthermore, if desired the bottom end 68 of the outer wall 60 additionally or alternatively serves as a part of the patterning means.

The plurality of guides 66 are substantially triangular in shape. Each of the plurality of guides 66 extends from the inner wall 62. As will be described in greater detail below, the plurality of guides 66 are optionally adapted to assist in directing, or aligning, the border press 50 over a portion of a baking vessel, such as a rim of a pan.

The center press 52 is positioned more proximate to the center Cₜ than the border press 50. The center press 52 defines a patterned bottom surface 86 and optionally includes a plurality of spokes 88, or cross members, connected to the border press 50 and meeting at the center Cₜ of the crimper 40. For example, the plurality of spokes 88 span the interior 58 of the border press 50, extending substantially radially from the center Cₜ to the inner wall 62 of the border press 50. Each of the plurality of spokes 88 defines a midline Mₜ and is angularly offset, midline-to-midline from an adjacent spoke as desired. For example, each of the plurality of spokes 88 is offset from an adjacent spoke a substantially similar angle, such as about 90 degrees. However, other angular offsets are also contemplated. Although four spokes 88 are shown, which in combination with the border press 50 divide the crimper 40 into four non-patterned quadrants, any number of spokes 88 is contemplated.

The plurality of spokes 88 are optionally substantially similar in shape and form, and as such are described cumulatively with respect to a first spoke 88a of the plurality of spokes 88. However, it should also be understood that spokes of differing shape and size are also contemplated. Regardless, the first spoke 88a defines a top 92 and a bottom 94. The first spoke 88a is optionally formed of a first angular-faced wall 100 and an opposing, second angular-faced wall 102, the two walls intersecting valley-to-valley such that the first spoke 88a, and in particular the patterned bottom 94 of the first spoke 88a is patterned, forming a series of interconnected diamond shapes connected along common points 104. In this manner, the patterned bottom 94 of the first spoke 88a and the patterned bottoms of a remainder of the plurality of spokes 88 defines the patterned bottom surface 86 of the center press 52. In particular, the patterned bottom surface 86 of the center press 52 optionally substantially corresponds to the inner pattern 22 of the pizza 10.

The first and second angular-faced walls 100, 102 are about 0.09375 inches thick and about 0.75 inches tall, for example. Each of the first and second angular-faced walls 100, 102 defines a series of 90 degree angles, with each of the plurality of diamond shapes being substantially square, for example. Additionally, the diamond shapes are connected point-to-point along the midline Mₜ. As will be described in greater detail below, an operator optionally aligns a cutting implement to the diamond shapes to determine where to cut the pizza 10. However, other dimensions and shapes, including other angles, are also contemplated. For example, the first spoke 88a optionally defines a series of connected circles, indicia such as words, images, branding designators, and others.

FIGS. 3A and 3B show the perforator 44 from top and bottom perspective views, respectively. The perforator 44 defines a center Cₚ, a top surface 110, and a bottom surface 112 and includes a plurality of perforating sections 116, a rim portion 118 optionally adapted to receive the border press 50 of the crimper 40, and a central portion 120 optionally adapted to receive the center press 52 of the crimper 40. The perforator 44 is substantially circular, although other shapes, such as rectangular, for example, are also contemplated. The perforator 44 is formed substantially continuously as a single piece, such that the perforator 44 is a monolithic, or substantially unitary, structure. However, separate, connected components are also contemplated. The perforator 44 or portions thereof are optionally opaque, translucent, or transparent.

The rim portion 118 extends about the center Cₚ of the perforator 44 and is substantially annular, or ring-shaped, although various shapes, for example rectangular shapes, are also contemplated. The rim portion 118 is optionally adapted to receive the border press 50 of the crimper 40. The rim portion 118 defines a maximum diameter of about 16.25 inches and a minimum diameter of about 14.8125 inches, such that the rim portion 118 is about 0.6875 inches wide, for example.

The central portion 120 is positioned more proximate to the center Cₚ than the rim portion 118. The central portion 120 includes a plurality of channel portions 124, also described as channels, extending to the rim portion 118 and meeting at the center Cₚ of the perforator 44. For example, the plurality of channel portions 124 extend substantially radially from the center Cₚ to the rim portion 118. Each of the plurality of channel portions 124 has a midline Mₚ and is angularly offset, midline-to-midline from an adjacent channel portion 124 if desired. Each of the plurality of channel portions 124 is optionally offset from an adjacent one of the plurality of channel portions 124 a substantially similar angle, such as about 90 degrees. However, other angular offsets are also contemplated.

A plurality of slots 122 are optionally formed through a corresponding one of the plurality of channel portions 124. The plurality of slots 122 are substantially elongate with rounded ends, about 0.5 inches wide, and about 5.5 inches long, for example. It should be understood that different shapes, including different dimensions, are also contemplated.

Although four are shown in FIGS. 3A and 3B, any number of channel portions 124 is acceptable. Additionally, each of the plurality of channel portions 124 is substantially similar to the other, although differing channel portions are also contemplated. In general terms, each of the plurality of channel portions 124 is adapted to receive one of the plurality of spokes 88 of the crimper 40. Each of the plurality of channel portions 124 is about 1.5 inches wide, for example. It should be noted that other dimensions are also contemplated.

Each of the plurality of perforating sections 116 includes a base 126 and a plurality of projections 128, also described as spikes, points, or other types of projections, extending from the respective bases 126. Each of the plurality of perforating sections 116 is substantially similar, and as such, some features are described cumulatively in relation to a first perforating section 116a. However, differing perforating sections 116 are also contemplated.

In particular, the first perforating section 116a defines a first base 126a and includes a first plurality of projections 128a. The first base 126a is optionally substantially planar with each of the plurality of projections 128a extending substantially orthogonally from the first base 126a. Each of the plurality of projections 128a is substantially similar, though differing projections are contemplated. Each of the first plurality of projections 128a is substantially conical in shape, or is otherwise pointed, and is optionally rounded, or sharp-tipped as desired. Each of the first plurality of projections 128a is about 0.375 inches tall as measured from the first bottom face 126a, and defines a maximum diameter of about 0.25 inches, for example. It should be understood that other shapes and dimensions are also contemplated.

Each of the plurality of perforating sections 116 is spaced from an adjacent one of the plurality of perforating sections 116. For example, the plurality of perforating sections 116 are optionally bounded by the rim portion 118 with corresponding ones of the plurality of channel portions 124 disposed between adjacent perforating sections. In this manner, each of the plurality of perforating sections 116 defines a pie-shape, the perforating sections 116 each defining one of four quadrants, although other shapes and other numbers of perforating sections 116 are also contemplated.

When viewed from the top perspective view of FIG. 3A, each of the plurality of perforating sections 116 is optionally depressed relative to the rim portion 118 and the central recessed portion 120. In turn, when viewed from the bottom perspective view of FIG. 3B, each of the plurality of perforating sections 116 optionally protrudes relative to the rim portion 118 and the central recessed portion 120.

When viewed from the bottom, the rim portion 118 and the central recessed portion 120 are each optionally recessed relative to bases 126 of the plurality of perforating sections 116 about 0.375 inches. Similarly, for example, rim portion 118 and the central recessed portion 120 are each optionally recessed relative to the pluralities of projections 128 about 0.75 inches, for example. In turn, the plurality of perforating sections 116 are each optionally recessed relative to the rim portion 118 and the central recessed portion 120 at the top surface 110 about 0.375 inches, although other dimensions are contemplated.

FIGS. 4A and 4B are top and bottom perspective views of the divider 48. The divider 48 defines a center C_{d} and an interior 136 and includes a border cover 140, also described as an outer cover, and an inner cover 142, the border cover 140 and the inner covers 142 together defining a plurality of compartmentalized openings 146 through the divider 48. The divider 48 is optionally formed substantially continuously, as a single piece, such that the divider 48 is a monolithic, or substantially unitary, structure. However, separate, connected components are also contemplated. The divider 48 or portions thereof are opaque, translucent, or transparent as desired.

The border cover 140 extends about the center C_{d} of the divider 48 and is substantially annular, or ring-shaped, although other shapes, such as rectangular, square, or triangular shapes, for example, are also contemplated. The border cover 140 optionally includes an outer wall 150, an inner wall 152, a top wall 154, and a plurality of supports 156.

The outer wall 150 is substantially smooth and projects downwardly from the top wall 154 and is stepped to define a shoulder 164. The outer wall 150 optionally extends substantially orthogonally from the top wall 154 or at a substantially obtuse angle from the top wall 154, although other angles are contemplated. The outer wall 150 optionally defines an outer transverse perimeter of the border cover 140 at a diameter of about 17.28125 inches, for example. It should be understood that other dimensions are also contemplated.

The inner wall 152 borders the interior 136 of the divider 48, is substantially smooth, and projects downwardly from the top wall 154. For example, the inner wall 152 extends substantially orthogonally from the top wall 154 or at a substantially obtuse angle from the top wall 154, although other angles are also contemplated. The inner wall 152 defines the interior 136 at a diameter of about 14.6875 inches, although other dimensions are contemplated.

The top wall 154 is optionally substantially solid, also described as closed, and adapted to shield dough covered by the border cover 140. The top wall 154 defines a top face 166 and a bottom face 168. As referenced above, the top wall 154 extends between the inner and outer walls 150, 152. The top wall 154 has a width of about 1.0 inches and a thickness between the top face 166 and the bottom face 168 of about 1.1875 inches, although other dimensions are contemplated.

With reference to FIG. 4C, each of the plurality of supports 156 is substantially trapezoidal in shape and each optionally extends from the bottom face 168 of the top wall 154 and proximate the shoulder 164 of the outer wall 150. The plurality of supports 156 are optionally distributed about the border cover 140, for example at locations aligned to portions of the inner cover 142. As will be described in greater detail below, the plurality of supports 156 are optionally used to guide the divider 48 onto a pizza pan and/or to imprint the cutting marks 26 into the pizza 10, for example.

With reference to FIGS. 4A and 4B, the inner cover 142 is positioned more proximate to the center C_{d} than the border cover 140 and includes a plurality of cross members 174, or spokes, connected to the border cover 140 and meeting at the center C_{d} of the divider 48. For example, the plurality of cross members 174 span the interior 136 of the divider 48, extending substantially radially from the center C_{d} to the inner wall 152 of the border cover 140. Each of the plurality of cross members 174 defines a midline M_{d} and is angularly offset, midline-to-midline, from an adjacent cross member as desired. For example, each of the plurality of cross members 174 is optionally offset from an adjacent one of the plurality of cross members 174 a substantially similar angle, such as about 90 degrees. However, other angular offsets are also contemplated. Additionally, numbers of the plurality of cross members 174 are varied as desired, although four are shown in FIGS. 4A and 4B.

The plurality of cross members 174 are optionally substantially similar in shape and form, and as such are described cumulatively with respect to a first cross member 174a. However, it should also be understood that cross members of differing shape and form are also contemplated. Regardless, the first cross member 174a optionally includes a first wall 180, a second wall 182, and a top wall 184. The first and second walls 180, 182 are positioned in an opposing manner, are substantially parallel, and each extends substantially orthogonally from the top wall 184 or at a substantially obtuse angle to the top wall 184, although other angles are contemplated.

The top wall 184 is adapted to shield some or all of the exposed portions 18 of the common crust 14 covered by the inner cover 142. The top wall 184 defines a top face 186 and a bottom face 188. As referenced above, the top wall 184 extends between the inner and outer walls 180, 182. The top wall 184 has a width of about 1.1875 inches, although other dimensions are contemplated.

The plurality of compartmentalized openings 146, otherwise described as individual or segmented openings, are formed through the divider 48. Each of the plurality of compartmentalized openings 146 is defined by the combination of the border cover 140 and corresponding ones of the plurality of cross members 174. Each of the plurality of compartmentalized openings 146 is substantially similar, although differing openings are contemplated. Each of the plurality of compartmentalized openings 146 is pie-shaped, although other shapes, for example rectangles, are also contemplated.

In view of the above, a method of making the pizza 10 includes assembling the crimper 40 and the perforator 44, texturizing and perforating the crust 14 with the assembled crimper and perforator 40, 44, selectively forming the individualized topping sections 22a-d with the divider 48, baking the pizza 10, and cutting the pizza 10. It should be understood that a reordering of some of the steps, including substeps associated therewith, is also contemplated.

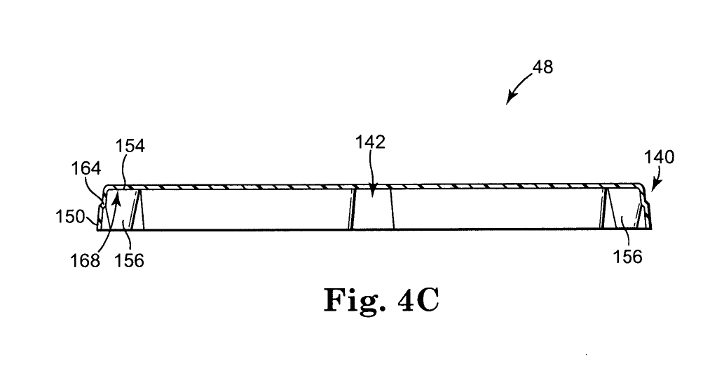

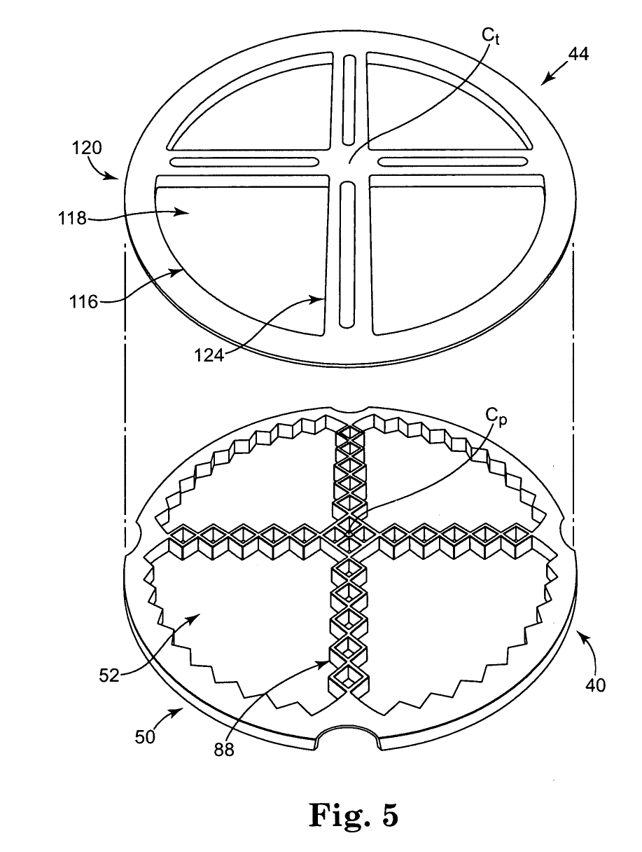

With reference to FIGS. 5 and 6, assembly of the crimper 40 and the perforator 44 is described. FIG. 5 illustrates the crimper 40 aligned with the perforator 44 prior to completing assembly of the crimper 40 and the perforator 44, while FIG. 6 illustrates an assembled crimper and perforator 40, 44. The crimper 40 and the perforator 44 are optionally adapted to define a complementary fit with one another. In particular, the border press 50 of the crimper 40 is optionally received against the bottom surface 112 (FIG. 3B) of the perforator 44, and in particular at the rim portion 118 of the perforator 44, with the patterned bottom surface 56 (FIG. 2B) of the border press 50 facing away from the perforator 44.

In turn, the center press 52 of the crimper 40 is received against the bottom surface 112 (FIG. 3B) of the perforator 44 at the central recessed portion 120. For example, the plurality of spokes 88 of the crimper 40 are aligned to the plurality of channel portions 124 and received between the plurality of perforating sections 116 of the perforator 44 with the patterned bottom surface 86 (FIG. 2B) of the center press 52 facing away from the perforator 44.

Once assembled into a single unit, the patterned bottom surfaces 56, 86 (FIG. 2B) of the crimper 40 are optionally substantially coterminous with the pluralities of projections 128 (FIG. 3B), are optionally recessed relative to the pluralities of projections 128, or optionally project beyond the pluralities of projections 128. Regardless, perforating, also described as docking, and texturizing, also described as patterning or crimping, are optionally achieved substantially simultaneously using the crimper 40 and/or the perforator 44 at substantially the same time and/or as part of a single operation.

With reference to FIG. 6, advantages in alignment, for example, are also achievable. In particular, when viewing the assembly from the top, the plurality of slots 122 allow the plurality of spokes 88 to be viewed through the perforator 44. Furthermore, anything under the spokes 88, for example, a portion of the pizza 10, is optionally viewed through the diamond shapes of the plurality of spokes 88. It should also be noted that various components of the crimper 40 and/or perforator 44 are optionally translucent or transparent to assist in looking through the crimper 40 and/or perforator 44 if desired.

Texturizing and perforating the common crust 14 includes aligning the assembled crimper and perforator 40, 44 to the crust 14. The crust 14 is optionally formed by substantially flattening a raw piece of dough into a substantially rounded shape, although other shapes, rectangular for example, are also contemplated. The crust 14 is optionally stretched or drawn out and maintained in a pan 210 or other appropriate vessel. The pan 210 optionally includes a lip 212, also described as an edge or a rim, and is substantially round, although other shapes, rectangular, for example, are also contemplated.

The assembled crimper and perforator 40, 44 are aligned such that the outer wall 60 of the border press 50 is disposed over the lip 212 of the pan 210. The plurality of guides 66 optionally assist in aligning the outer wall 60 over the lip 212. In particular, the plurality of guides 66 slide against the lip 212 and assist in centering the assembled crimper and perforator 40, 44 to the pan 210. The patterned bottom surfaces 56, 86 and the plurality of projections 128 of the assembled crimper and perforator 40, 44 are pressed downward onto the common crust 14 in a substantially simultaneous docking and crimping operation.

Following docking and crimping, the assembled crimper and perforator 40, 44 are removed from the common crust 14. For example, fingers are optionally inserted into the plurality of grip openings 70 and the crimper 40 is pulled upwardly away from the crust 14. Various topping selections are optionally placed on the topping support portions 20 immediately after texturizing and docking, or the crust 14 is optionally frozen, if desired.

With reference to FIG. 7, the perforations 28 are shown formed, or imprinted, into the common crust 14 by the plurality of projections 128. The outer and inner patterns 24, 22 are imprinted into the crust 14 by the border press 50 and the center press 52, respectively. As referenced above, the perforations 28, the inner pattern 22, and the outer pattern 24 are optionally imprinted, or formed, substantially simultaneously and/or as a single operation.

As will be understood with reference to the text that follows, the inner and outer patterns 22, 24 substantially correspond to boundaries, or lines of demarcation, between adjacent topping support portions 20 of the pizza 10. In particular, exposed portions 18 of the crust 14 are characterized by one of the first and second patterns 22, 24 while the topping support portions 20 of the crust 14 are characterized by the perforations 28.

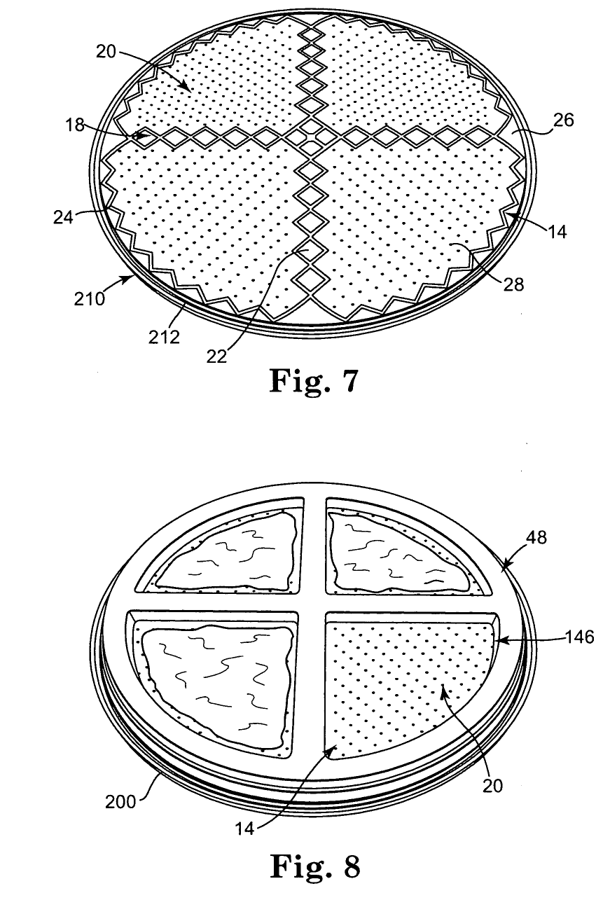

With reference to FIG. 8, the individualized topping sections 12a-d are selectively formed using the divider 48. In particular, the divider 48 is placed over the crust 14 to mask, or shield, the exposed portions 18 (FIG. 7) of the crust 14 while leaving the topping support portions 20 accessible through the plurality of compartmentalized openings 146 of the divider 48.

In particular, the plurality of cross members 174 of the inner cover 142 are optionally aligned to the inner pattern 22 (FIG. 7) in the crust 14 with the border cover 140 over the outer pattern 24 (FIG. 7), such that the plurality of cross members 174 and the border cover 140 are disposed over exposed portions 18 (FIG. 7) of the crust 14. The topping support portions 20 are left accessible, or exposed, through the plurality of compartmentalized openings 146. The plurality of supports 156 (FIG. 3C) are also optionally aligned to the outer pattern 24. In particular, the plurality of supports 156 are disposed to imprint the cutting marks 26 in alignment with the inner pattern 22 and into the crust 14. The cutting marks 26 are optionally used, for example, as an additional indicator to assist in determining where to cut the crust 14.

Regardless, the shoulder 164 of the border cover 140 is optionally seated against the lip 212 (FIG. 7) of the pan 210. Furthermore, the plurality of supports 156 optionally assist in guiding the shoulder 164 against the lip 212 of the pan 210. In particular, the lip 212 slides against the plurality of supports 156 as the divider 48 is moved downward onto the pan 210.

Once the divider 48 has been aligned and seated, topping selections are disposed through the plurality of compartmentalized openings 146 onto the topping support portions 20 of the common crust 14 to form the plurality of individualized topping sections 12a-d on the top face 16 of the common crust 14. Each of the plurality of individualized topping sections 12a-d optionally includes different topping selections, the same topping selections, or varied topping selections as desired. In this manner, a plurality of individual, or otherwise separate, open-faced pies is formed on the common crust 14.

Once the plurality of individualized topping sections 12a-d have been formed on the crust 14, or the pizza 10 has been otherwise assembled, the pizza 10 is optionally frozen or baked as desired. For example, the pizza 10 is optionally baked from a substantially raw, or uncooked state, to a cooked state at about 450 degrees F. for about 8 minutes.

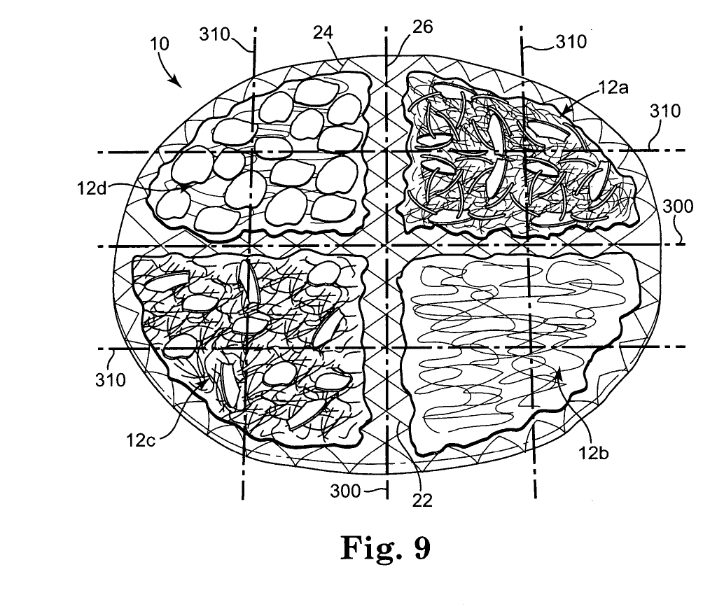

With reference to FIG. 9, the pizza 10 is cut into portions as desired. For example, the pizza 10 is optionally cut along cutting lines 300 corresponding to the inner pattern 22. In this manner, the common crust 14 is cut between the individualized topping sections 12a-d. In particular, a cutting knife is optionally aligned to the diamond shape of the inner pattern 22, for example point-to-point along the diamond pattern such that the diamond shapes of the inner pattern 22 are cut into to halves, each half substantially similar to the jagged line shape of the outer pattern 24. In this manner, following cutting along the lines 300, a substantially continuous pattern is defined about each of the plurality of individualized topping sections 12a-d. Such continuous patterning optionally presents a more uniform, and visually pleasing appearance upon cutting the pizza 10.

Cutting lines 300 also optionally correspond to portions of the outer pattern 24 and/or to the cutting marks 26. A secondary series of cuts is also optionally formed along cutting lines 310 to divide each of the plurality of individualized toppings sections 12a-d into portions.

Various advantages are optionally accomplished with reference to the above description. For example, one topping type intended for one portion of the pizza 10 is better maintained on that portion of the pizza 10. As another example, there is a reduced chance that toppings will slide off their intended portions of the pizza 10 when the pizza 10 is cut. For example, the exposed portions 18 of the crust 14 serve as barriers to help prevent such sliding. As yet another example, the pizza 10 is more easily cut between differently prepared portions. In particular, the inner pattern 22, the outer pattern 24, and/or the cutting marks 26 are optionally used to facilitate more precise, or accurate, cutting of the pizza 10. Additionally, docking and patterning are optionally performed as a single operation for increased efficiency and/or accuracy of perforation and/or pattern location. In sum, combining pizza variations on a common crust 14 is made less challenging, and consumers can enjoy multiple types of pizza in a single serving. For example, embodiments of the present allow customization for large and small families, great topping variety, and/or greater customization in larger size pizzas.

Although the invention has been described with respect to particular embodiments, such embodiments are for illustrative purposes only and should not be construed to limit the invention. Various alternatives and changes will be apparent to those of ordinary skill in the art. For example, although disclosed above as being formed in a particular shape or of a particular size, other suitable shapes and sizes are also contemplated. Other modifications within the scope of the invention and its various embodiments will be apparent to those of ordinary skill.

What is claimed is:

1. A pizza making system comprising:
a crimper defining a patterned bottom surface adapted to imprint patterns in a flattened dough member; and
a perforator including a plurality of projections adapted to form perforations in the dough member;
wherein the crimper and the perforator are separate items adapted to be assembled together in a substantially complementary fit to define a single unit such that the patterned bottom surface of the crimper and the plurality of projections of the perforator are positioned and configured to perform a single crimping and perforating operation on the dough member.

2. The system of claim 1, wherein the crimper defines a center, the crimper comprising:
a border press extending about the center of the crimper, the border press including a patterned bottom surface for imprinting an outer pattern in the dough member; and
a center press including a plurality of spokes extending outwardly from the center of the crimper to the border press, each of the plurality of spokes including a patterned bottom surface for imprinting an inner pattern in the dough member.

3. The system of claim 2, wherein the patterned bottom surfaces of each of the plurality of spokes define a pattern including a series of interconnected diamond shapes.

4. The system of claim 3, wherein the patterned bottom surface of the border press defines a pattern including a substantially continuous and jagged line.

5. The system of claim 2, wherein the perforator comprises:
a plurality of perforating sections having projections; and
a plurality of channels substantially free of projections, the plurality of channels separating each of the plurality of perforating sections from an adjacent perforating section;
wherein each of the plurality of spokes of the crimper is receivable in one of the plurality of channels of the perforator when the perforator and the crimper are assembled together.

6. The system of claim 2 further comprising:
a topping guide defining a center and comprising:
a border cover extending about the center of the topping guide and defining an interior, the border cover including a top wall adapted to shield portions of the dough imprinted with the outer pattern; and
a central cover including a plurality of cross members spanning the interior of the border cover, each of the plurality of cross members defining a top wall adapted to shield portions of the dough imprinted with the inner pattern;
wherein the border cover and the central cover together define a plurality openings in the topping guide, each opening separated from an adjacent opening by one of the plurality of cross members of the central cover.

7. The system of claim 2, wherein the patterned bottom surfaces of the border press and the center press define four non-patterned quadrants.

8. A method of making a pizza comprising:
assembling a patterning article to a docker to form a single unit, the docker including a plurality of projections and the patterning article including a patterned bottom surface;
imprinting a common crust with an inner pattern at an inner portion of the crust and an outer pattern at an outer portion of the crust using the patterning article such that the common crust defines a plurality of topping support sections bounded by the inner and outer patterns;
perforating the common crust with the docker to form a plurality of perforations in each of the plurality of topping support sections.

9. The method of claim 8, wherein the patterning article defines a center and includes a border portion and a plurality of spokes radiating outwardly from the center to the border portion, wherein the docker defines a center and includes a plurality of perforation sections, each of the plurality of perforation sections separated by a plurality of recessed areas radiating outwardly from the center of the docker, and further wherein assembling the patterning article to the docker includes disposing the plurality of spokes of the patterning article in the plurality of recessed areas of the docker to define a substantially complementary fit.

10. The method of claim 8, wherein imprinting the common crust and perforating the common crust are performed substantially continuously as a single operation.

11. A method of making a pizza comprising:
forming a crust defining a top face;
aligning a cover to the crust, the cover including a border extending about a center of the cover and a plurality of cross members each connected to the border and spanning an interior of the cover, the outer cover and the plurality of cross members together defining a plurality of openings through the cover;
covering a portion of the crust with the cover such that the top face of the crust is masked by the inner and outer portions of the cover and a plurality of topping support sections associated with the crust are exposed through the plurality of openings in the cover; and
disposing a topping selection onto each of the plurality of topping support sections through the plurality of openings in the cover to form a plurality of individualized topping sections on the crust.

12. The method of claim 11, further comprising:
patterning the common crust with an inner pattern and an outer pattern, the inner and outer patterns together bounding the plurality of topping support sections of the crust;
wherein aligning the cover to the crust includes aligning the plurality of cross members to the inner pattern and aligning the outer cover to the outer pattern.

13. The method of claim 12, further comprising:
baking the crust and the topping selections disposed on each of the plurality of topping support sections.

14. The method of claim 13, further comprising:
separating the crust along the inner pattern of the crust extending between the plurality of individualized topping sections.

15. The method of claim 12, further comprising:
imprinting a plurality of perforation marks into each of the plurality of topping support sections of the crust.

16. The method of claim 15, wherein the plurality of perforation marks and the inner and outer patterns are imprinted substantially simultaneously into the crust.

17. The method of claim 12, wherein the outer pattern extends about the plurality of individualized topping sections and the inner pattern extends between adjacent ones of the plurality of individualized topping sections.

18. The method of claim 17, wherein the inner pattern comprises a plurality of interconnected diamond shapes and the outer pattern comprises a serrated line.

19. A pizza comprising:
a substantially flattened dough member defining a top surface;
a plurality of self-contained topping portions maintained on the top surface of the dough member, each of the plurality of self-contained topping portions including a topping selection and being surrounded by an exposed portion of the top surface of the dough member;
wherein the exposed portion of the top surface of the dough member is imprinted with a first pattern extending between each of the plurality of self-contained topping portions and a second pattern extending about the plurality of self-contained topping portions.

20. The pizza of claim 19, wherein the dough member defines an inner portion and an outer portion, and further wherein the first pattern includes a series of diamond shapes connected point-to-point across the inner portion of the dough member and the second pattern includes a jagged line extending about the outer portion of the dough member.
